(19) United States
(12) Patent Application Publication
(10) Pub. No.: US 2006/0214564 A1
(43) Pub. Date: Sep. 28, 2006

(54) Organic electroluminescent display and method for fabricating the same

(76) Inventor: Hsi-Ming Chang, Bade City (TW)

Correspondence Address: J C PATENTS, INC., 4 VENTURE, SUITE 250, IRVINE, CA, 92618, US

(21) Appl. No.: 11/089,821

(22) Filed: Mar. 24, 2005

(51) Int. Cl. H05B 33/22; H05B 33/02; H05B 33/10

(52) U.S. Cl. 313/504; 313/503; 313/506; 445/24

(57) ABSTRACT

An organic electroluminescent display and a method for fabricating the same are provided. The present invention provides an organic electroluminescent display panel, including: a substrate with a plurality of pixel regions, wherein a device region and a light-emitting region is defined in each pixel region; an active device array, disposed in the device regions of the substrate; a transparent electrode layer, disposed over the substrate and coupled to the active device array; a light-shielding layer, disposed over the substrate, wherein the light-shielding layer at least covers the active device array and exposes the transparent electrode layer in the light-emitting regions; an organic functional layer, disposed over the transparent electrode layer exposed by the light-shielding layer; and an upper electrode layer, disposed over the organic functional layer.

### BACKGROUND OF THE INVENTION

1. Field of the Invention

The present invention generally relates to a planet display and a method of fabricating the same. More particularly, the present invention relates to an organic electroluminescent display and a method of fabricating the same.

2. Description of Related Art

As multi-media technology advances, a variety of semiconductor devices or displays have been rapidly developed. The flat panel displays have such advantages as high resolution, high space-effectiveness, low power consumption and no radiation, and have become the main trend in this industry.

The display devices include liquid crystal display (LCD), organic electroluminescence display, plasma display panel (PDP) and so on. The organic electroluminescence display is an array display with emissive devices. The organic electroluminescence display, with its wide-view angle, low manufacturing cost, high-speed response (about hundreds of times faster than liquid crystal displays), low power consumption, compatibility with direct current (DC) portable devices, wide operational temperature, slim size and light weight, is more suitable for multi-media communication than other devices. Thus, the organic electroluminescence display has become the star performer in the display market in the next generation.

The organic electroluminescence display, according to the driving methods, can be divided into active and passive organic electroluminescence displays. The life span and the luminescent efficiency of the passively driving devices dramatically deteriorate with the increase of size and resolution. Though the conventional organic electroluminescence display uses low-end passively driving methods, the current organic electroluminescence display has adopted actively driving methods.

Currently, the active matrix organic electroluminescent display panel has been developed, which typically includes an organic functional layer formed over a substrate having, for example, a thin film transistor (TFT) array already formed thereon and a cathode layer formed on the organic functional layer. In this manner, the active matrix organic electroluminescent display panel is driven by the TFT array for emitting light.

In addition, the organic electroluminescent display panel can also be classified into bottom emission type and top emission type. The organic electroluminescent display panel of the bottom emission type has a transparent anode, an organic material layer, and a metallic cathode layer sequentially formed over a substrate. Although the light from the organic functional layer emits in all possible direction, light heading towards the top will be reflected downward by the metallic cathode layer. Ultimately, most of the light will emit from the bottom of the organic electroluminescent display panel after passing through the transparent anode layer.

FIG. 1 is a cross-sectional view schematically illustrating a conventional organic electroluminescent display panel of a bottom emission type. Referring to FIG. 1, the conventional organic electroluminescent display panel 100 comprises a substrate 110, a plurality of active devices 120 arranged on the substrate 110, a dielectric layer 130 formed over the substrate 110 to cover the active devices 120, a transparent electrode layer 140 formed over the dielectric layer 130 and coupled to the active devices 120 via openings 130a in the dielectric layer 130, an organic functional layer 150 formed over the transparent electrode layer 140, and a cathode layer 160 formed over the organic functional layer 150. Typically, the active devices 120 are usually composed of TFTs, wherein some TFTs are used for switching purpose and others are used for driving purpose. The TFTs can be amorphous silicon (a-Si) TFTs or low temperature poly-silicon (LTPS) TFTs.

However, the conventional organic electroluminescent display panel 100 still have some disadvantages. For example, the silicon layer in the TFTs would generate photo-leakage current when irradiated by the light source generated by the organic functional layer. The photo-leakage current not only affects the performance of the TFTs itself, but also brings in problems such as flickering or cross-talk when a frame on display. In addition, the light leakage from adjacent pixels may cause light mixture and thus diminishes the contrast effect.

### SUMMARY OF THE INVENTION

Accordingly, the present invention is directed to an organic electroluminescent display panel and a method of fabricating the same, which is capable of substantially preventing the photo-leakage current of the active devices and reducing the light leakage of adjacent pixels by isolating the active devices from the light emitted from the organic functional layer.

The present invention provides an organic electroluminescent display panel, which comprises: a substrate with a plurality of pixel regions, wherein a device region and a light-emitting region is defined in each pixel region; an active device array, disposed in the device regions of the substrate; a transparent electrode layer, disposed over the substrate and coupled to the active device array; a light-shielding layer, disposed over the substrate, wherein the light-shielding layer at least covers the active device array and exposes the transparent electrode layer in the light-emitting regions; an organic functional layer, disposed over the transparent electrode layer exposed by the light-shielding layer; and an upper electrode layer, disposed over the organic functional layer.

According to an embodiment of the present invention, the organic electroluminescent display panel further comprises a dielectric layer disposed over the substrate to cover the active device array, wherein the dielectric layer has a plurality of openings to expose a portion of the active device array, and the transparent electrode layer is coupled to the active device array via the openings.

According to an embodiment of the present invention, the dielectric layer mentioned above further exposes the light-emitting region of the substrate, on which a portion of the transparent electrode layer is disposed.

According to an embodiment of the present invention, the active device array comprises a plurality of amorphous silicon thin film transistors (a-Si TFTs) or a plurality of low temperature poly-silicon thin film transistors (LTPS TFTs).

According to an embodiment of the present invention, the material of the transparent electrode layer comprises indium-tin oxide (ITO) or indium-zinc oxide (IZO).

According to an embodiment of the present invention, the material of the light-shielding layer is photosensitive resin.

According to an embodiment of the present invention, the organic functional layer comprises a hole injection layer, a hole transporting layer, an emitting layer, an electron transporting layer, and an electron injecting layer that are stacked sequentially.

The present invention also provides a method of fabricating the organic electroluminescent display panel. First, an active device array substrate with a plurality of pixel regions is provided, wherein a device region and a light-emitting region is defined in each pixel region, an active device array is formed in the device regions of the substrate, and a transparent electrode layer is formed over the substrate and coupled to the active device array. Then, a light-shielding layer is formed over the substrate, wherein the light-shielding layer at least covers the active device array and exposes the transparent electrode layer in the light-emitting regions. Next, an organic functional layer is formed over the transparent electrode layer exposed by the light-shielding layer. Further, an upper electrode layer is formed over the organic functional layer.

According to an embodiment of the present invention, the steps of forming the light-shielding layer comprise forming a light-shielding material layer over the substrate and patterning the light-shielding material layer to expose the transparent electrode layer in the light-emitting regions. In addition, the material of the light-shielding material layer may be photosensitive resin, and a photolithography process is performed for patterning the light-shielding material layer.

According to an embodiment of the present invention, before forming the transparent electrode layer, a dielectric layer with a plurality of openings for exposing a portion of the active device array is formed over the substrate, and the transparent electrode layer is coupled to the active device array via the openings. In addition, the dielectric layer further exposes the light-emitting region of the substrate, on which a portion of the transparent electrode layer is disposed.

According to an embodiment of the present invention, the step of forming the organic functional layer comprises forming a hole injection layer, a hole transporting layer, an emitting layer, an electron transporting layer, and an electron injection layer sequentially.

Since that the active device is protected by the light-shielding layer in the organic electroluminescent display panel of the present invention, the problem of the photo-leakage current can be prevented, and the light leakage of adjacent pixels can be reduced. Therefore, the organic electroluminescent display panel in the present invention can provide higher reliability and display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view schematically illustrating a conventional organic electroluminescent display panel of a bottom emission type.

FIG. 2 is a cross-sectional view schematically illustrating an organic electroluminescent display panel according to one embodiment of the present invention.

FIGS. 3A through 3F are schematic cross-sectional views showing the steps for fabricating an organic electroluminescent display panel with a-Si TFTs in one embodiment of the present invention.

FIGS. 4A through 4H are schematic cross-sectional views showing the steps for fabricating an organic electroluminescent display panel with LTPS TFTs in another embodiment of the present invention.

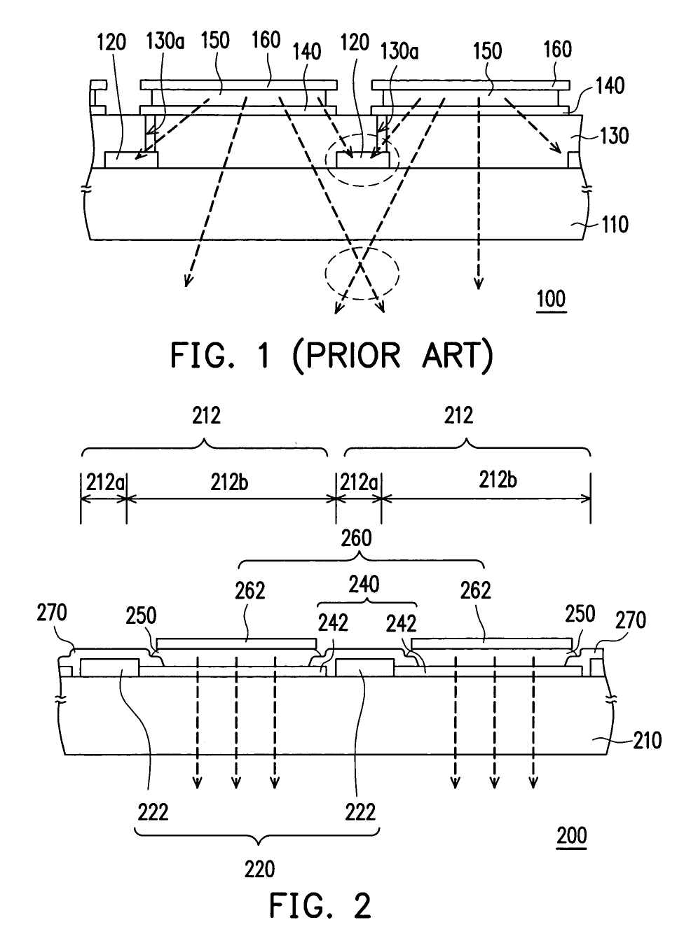

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a drawing of cross-sectional view, schematically illustrating an organic electroluminescent display panel according to one embodiment of the present invention. Referring to FIG. 2, the organic electroluminescent display 200 comprises a substrate 210, an active device array 220, a transparent electrode layer 240, a light-shielding layer 270, an organic functional layer 250, and an upper electrode layer 260. The substrate 210 has a plurality of pixel regions 212, wherein a device region 212a and a light-emitting region 212b is defined in each pixel region 212. The active device array 220, comprising a plurality of active devices 222, is disposed in the device regions 212a of the substrate 210.

Referring to FIG. 2, the transparent electrode layer 240 comprises a plurality of transparent electrodes 242, which are disposed over the substrate 210 and coupled to the corresponding active devices 222. The light-shielding layer 270 is disposed over the substrate 210 for at least covering the active devices 222 and exposing a portion of the transparent electrodes 242 in the light-emitting regions 212b. In addition, the organic functional layer 250 is disposed over the portion of the transparent electrodes 242 exposed by the light-shielding layer 270, and the upper electrode layer 260 comprises a plurality of upper electrodes 262, which are disposed over the organic functional layer 250.

Accordingly, the shielding layer 270 can protect the active devices 222 by blocking the light emitted from the organic functional layer 250. Therefore, the problem of the photo-leakage current can be substantially prevented, and the light mixture of the adjacent pixel regions can be reduced.

In the present embodiment, the active devices 222 may comprise amorphous silicon (a-Si) TFTs or low-temperature poly-silicon (LTPS) TFTs according to the material constituting the channel layer (not shown), wherein some TFTs are used for switching purpose (not shown in FIG. 2) and others are used for driving purpose. Certainly, the type of transistor used in the organic electroluminescent display panel is not limited thereto. In the following, the structure of the organic electroluminescent display panel 200 and the method for fabricating the same are disclosed in detail.

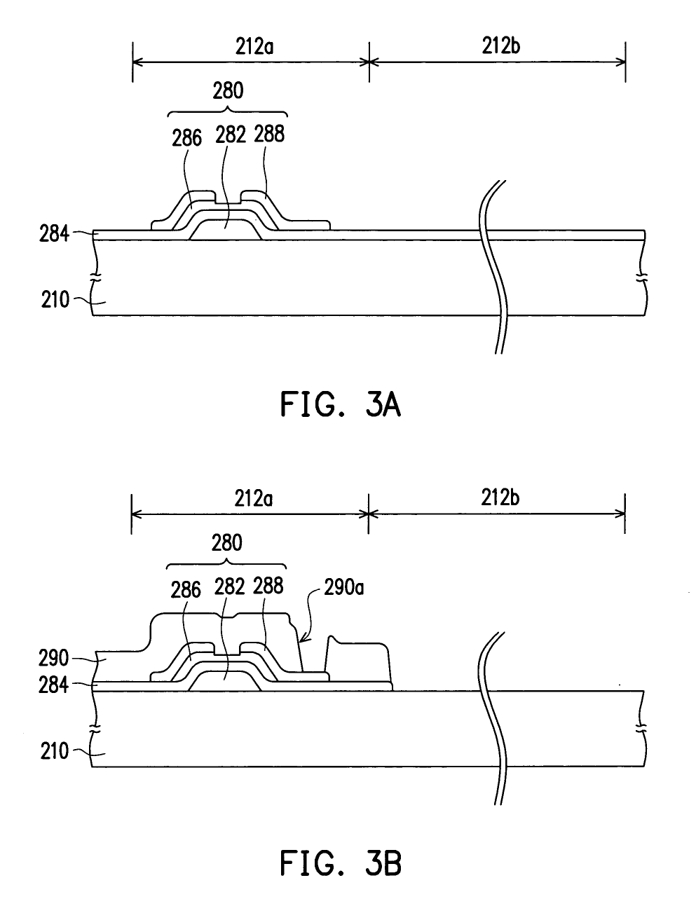

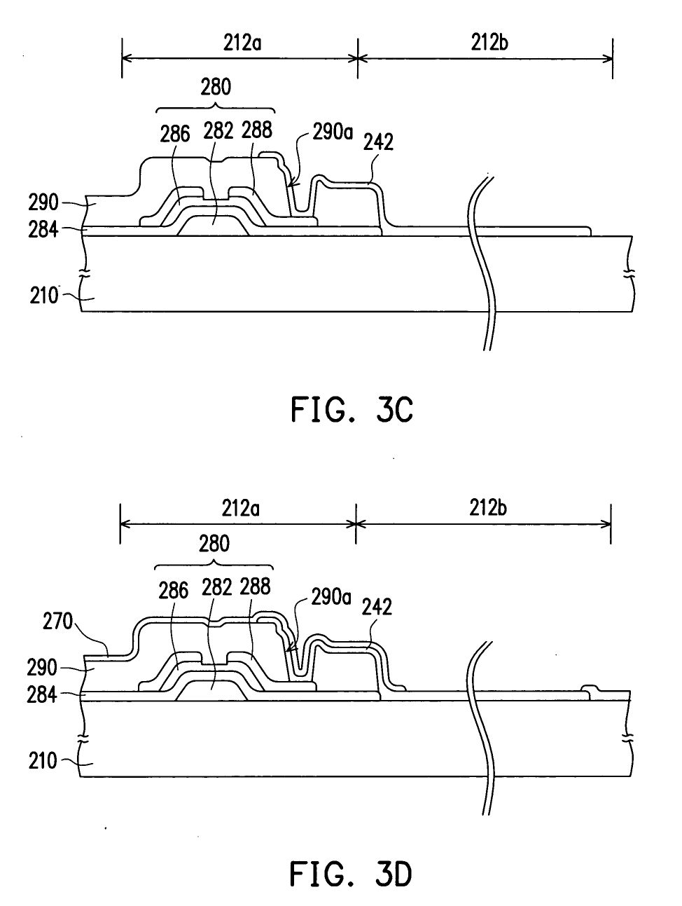

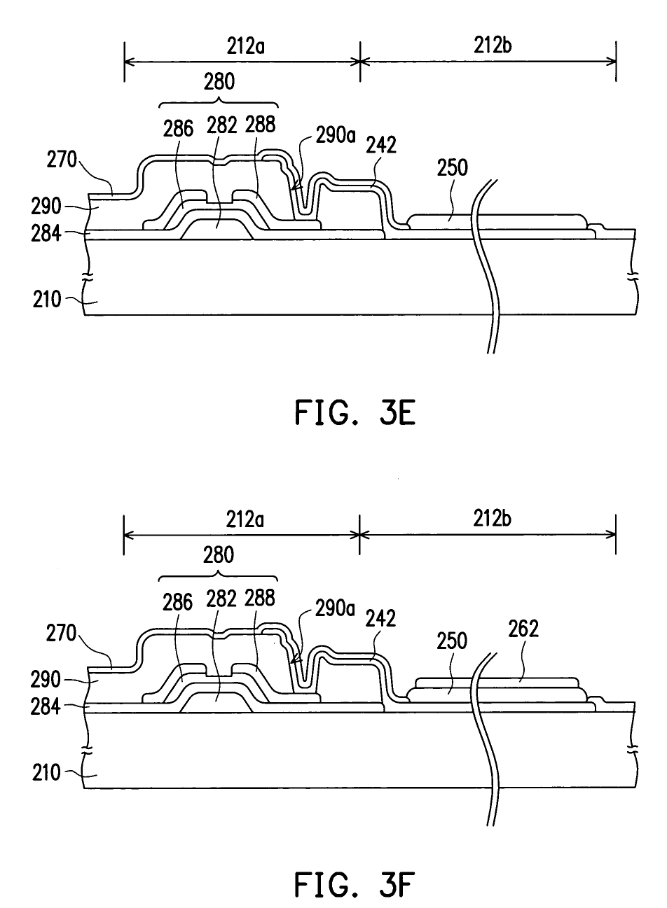

FIGS. 3A through 3F are schematic cross-sectional views showing the steps for fabricating an organic electroluminescent display panel with a-Si TFTs in one embodiment of the present invention. Though the organic electroluminescent display panel has many pixel structures thereon arranged as a matrix, FIGS. 3A through 3F illustrate the fabricating process of only one pixel structure for a clear and simple description.

As shown in FIG. 3A, a gate 282 is formed over the substrate 210, with the device region 212a and the light-emitting region 212b defined. Thereafter, the gate-insulating layer 284 is formed over the gate 282 and the substrate 210. The channel layer 286 is formed over the gate-insulating layer 284 above the gate 282, wherein the material constituting the channel layer 286 is amorphous silicon. Then, the source/drain 288 is formed on each side of the channel layer 286. Accordingly, the gate 282, the channel layer 286 and the source/drain 288 together form an a-Si TFT 280 in the device region 212a of the substrate 210.

Thereafter, as shown in FIG. 3B, the dielectric layer 290 is formed over the a-Si TFT 280. For example, the material constituting the dielectric layer 290 is silicon nitride. Next, a masking process is performed to form an opening 290a in the dielectric layer 290. Preferably, in the masking process, a portion of the dielectric layer 290 and the gate-insulating layer 284 in the light-emitting region 212b of the substrate 210 may also be removed.

Then, as shown in FIG. 3C, the transparent electrode 242 is formed over the dielectric layer 290 and coupled to the source/drain 288 of the a-Si TFT 280 via the opening 290a. In the preferred case, the dielectric layer 290 and the gate-insulating layer 284 expose the light-emitting region 212b of the substrate 210, and a portion of the transparent electrode 242 may be directly disposed on the light-emitting region 212b of the substrate 210. The transparent electrode 242 is formed, for example, by performing a chemical vapour deposition (CVD) process or a physical vapour deposition (PVD) process such as thermal evaporation, electron beam coating or sputtering. In particular, the transparent electrode 242 can be fabricated using a transparent conductive material, such as indium-tin oxide (ITO) or indium-zinc oxide (IZO).

Thereafter, as shown in FIG. 3D, the light-shielding layer 270 is formed over the substrate 210, wherein the material constituting the light-shielding layer 270 may be photosensitive resin. And then a photolithography process can be performed for patterning the light-shielding layer 270 to expose the transparent electrode 242 in the light-emitting region 212b.

Next, as shown in FIG. 3E, the organic functional layer 250 is formed over the transparent electrode 242 exposed by the light-shielding layer 270, for example, by performing a vacuum or thermal evaporation, a spin coating or other deposition process. One of ordinary skill in the art may select an appropriate deposition process according to the material chosen. In the present embodiment, the transparent electrode 242 is regarded as an anode and the organic functional layer 250 is a composite stack on the transparent electrode 242 comprising, from bottom to top, a hole injecting layer (HIL), a hole transporting layer (HTL), an emission layer (EL), an electron transporting layer (ETL), and an electron injecting layer (EIL). However, in another embodiment of the present invention, the organic functional layer 250 can also be a single layer (a bipolar emission layer), a double layer (comprising an hole transporting layer and an electron transporting emission layer), or a triple layer (comprising a hole transporting layer, an emission layer, and an electron transporting layer). Hence, the number of stack layers used in the organic function layer 250 is not limited in the present invention. In general, the number of stack layers depends on the design of the actual device.

After that, as shown in FIG. 3F, the upper electrode 262 is formed over the organic function layer 250. In this embodiment, the upper electrode 262 is a cathode layer and fabricated using a metallic material. Thus, according to the aforementioned fabricating process, the organic electroluminescent display panel 200 as shown in FIG. 2 can be produced.

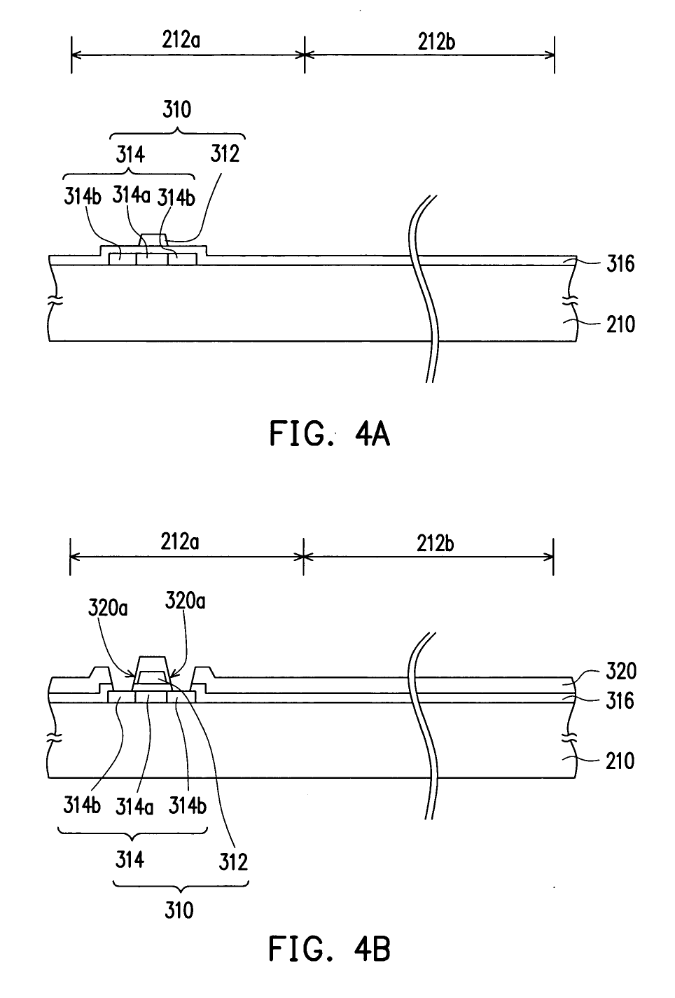

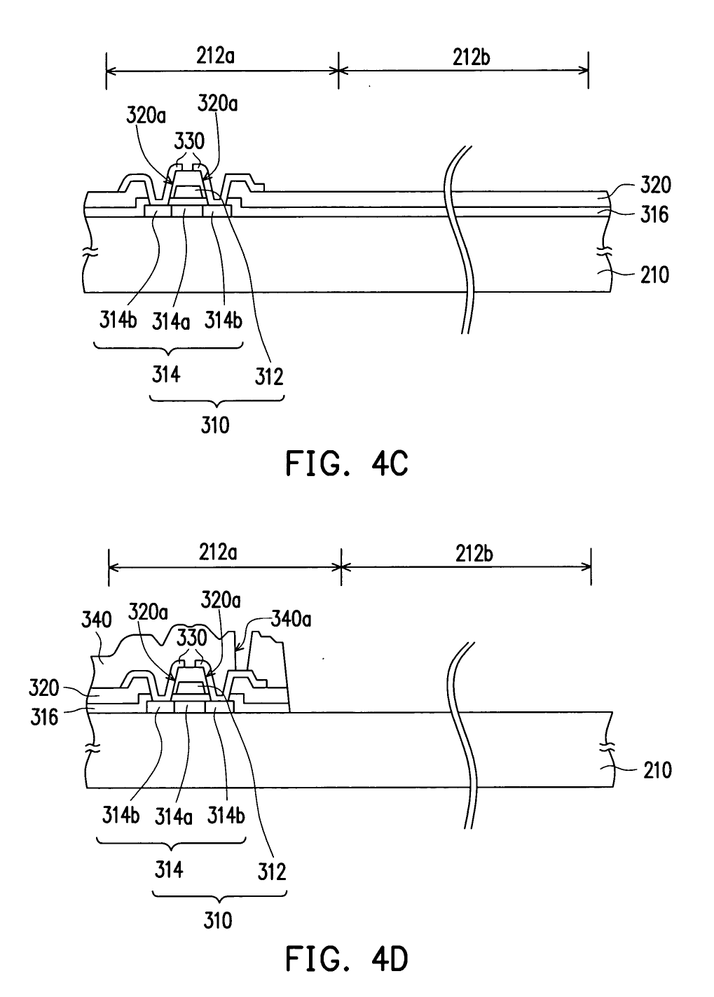

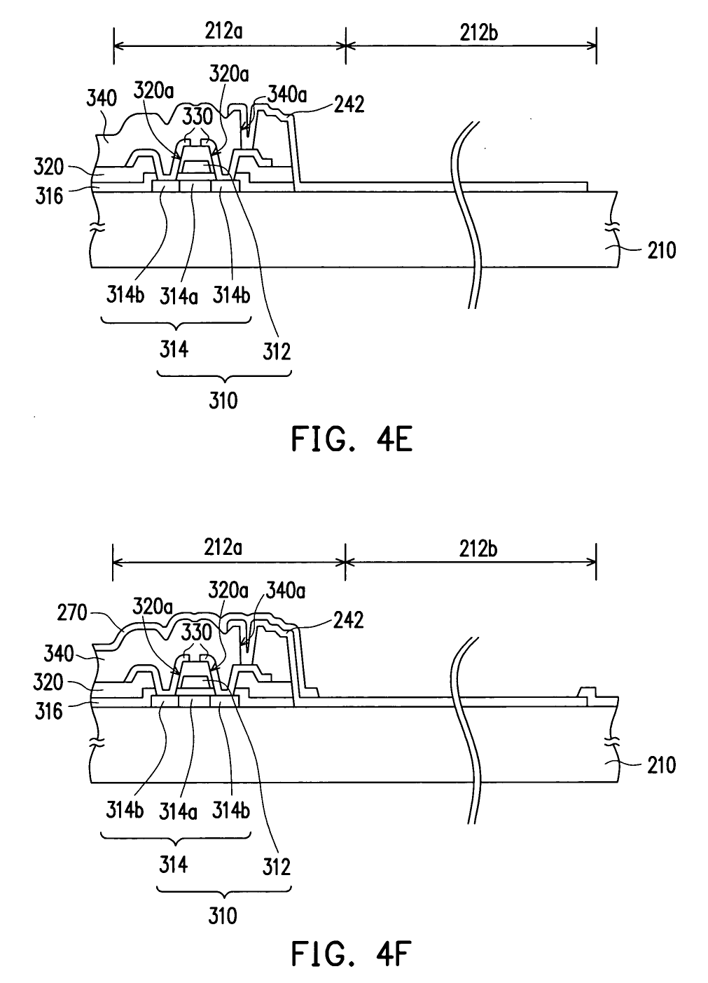

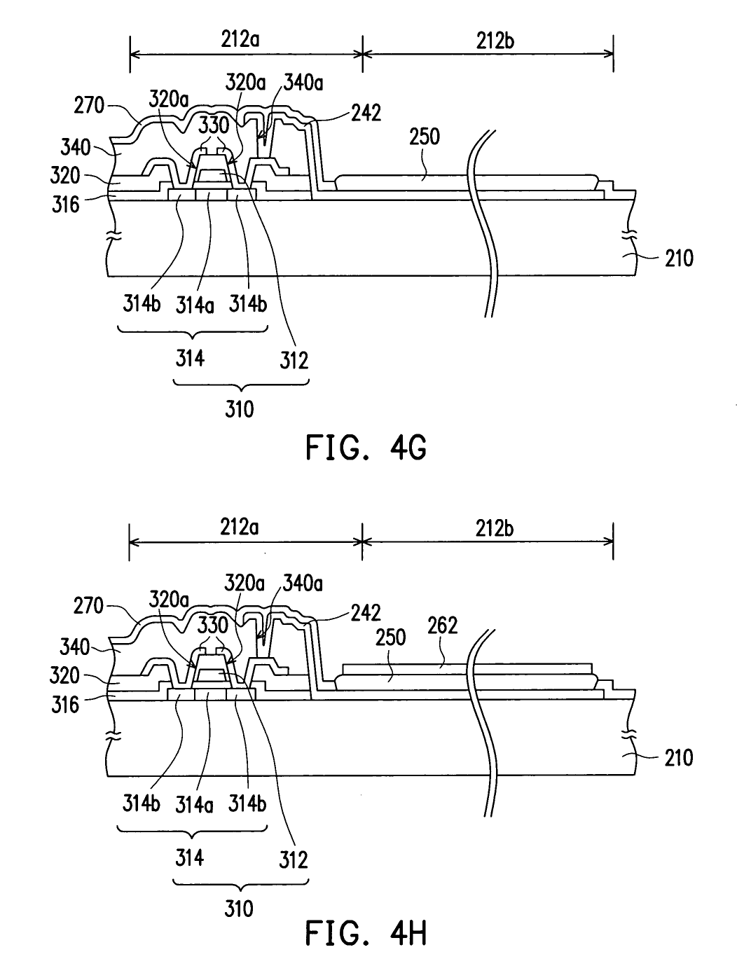

FIGS. 4A through 4H are schematic cross-sectional views showing the steps for fabricating an organic electroluminescent display panel with LTPS TFTs according to another embodiment of the present invention. Though the organic electroluminescent display panel has many pixel structures thereon arranged as a matrix, FIGS. 4A through 4H illustrate the fabricating process of only one pixel structure for a clear and simple description.

As shown in FIG. 4A, a LTPS TFT 310 is formed in the device region 212a of the substrate 210, wherein a gate 312 is positioned over the substrate 210, an island poly-silicon layer 314 is positioned between the gate 312 and the substrate 210. A gate-insulation layer 316 is positioned between the gate 312 and the island poly-silicon layers 314. Furthermore, the island poly-silicon layer 314 has a channel region 314a and a pair of doped source/drain region 314b. The channel region 314a is positioned underneath the gate 312 and the doped source/drain region 314b is positioned on each side of the channel region 314a. Since poly-silicon has such property as relatively high electron mobility, peripheral circuits including complementary metal-oxide-semiconductor (CMOS) transistors can also be fabricated as the LTPS TFT 310 is made. However, the detailed fabricating process of the above LTPS TFT 310 or CMOS transistors should be apparent to one of ordinary skill in the art, and detailed description is not repeated.

Thereafter, as shown in FIG. 4B, a dielectric inter-layer 320 is formed over the substrate 210 to cover the island poly-silicon layers 314 and the gate 312. And then, an opening 320a is formed in the dielectric inter-layer 320 and the gate-insulation layer 316 to expose a portion of the doped source/drain regions 314b.

Next, as shown in FIG. 4C, a source/drain metallic contact 330 is formed over the dielectric inter-layer 320 and coupled to the doped source/drain region 314b via the opening 320a.

Then, as shown in FIG. 4D, another dielectric layer 340 is formed over the substrate 210 to cover the source/drain metallic contact 330 and the dielectric inter-layer 320. Thereafter, an opening 340a that exposes a portion of the source/drain metallic contact 330 is formed in the dielectric layer 340 in a masking process, wherein the material constituting the gate-insulation layer 316, the dielectric inter-layer 320, and the dielectric layer 340 is silicon nitride, for example. Preferably, in the masking process, a portion of the gate-insulation layer 316, the dielectric inter-layer 320, and the dielectric layer 340 in the light-emitting region 212b of the substrate 210 may also be removed.

Next, as shown in FIG. 4E, the transparent electrode 242 is formed over the dielectric layer 340 and coupled to the source/drain metallic contact 330 via the opening 340a. In a preferred case, the gate-insulation layer 316, the dielectric inter-layer 320, and the dielectric layer 340 expose the light-emitting region 212b of the substrate 210, and a portion of the transparent electrode 242 may be directly disposed on the light-emitting region 212b of the substrate 210. In particular, the transparent electrode 242 can be fabricated using a transparent conductive material, such as indium-tin oxide (ITO) or indium-zinc oxide (IZO).

Thereafter, as shown in FIGS. 4F through 4H, the light-shielding layer 270, the organic functional layer 250, and the upper electrode 262 is formed over the substrate 210 sequentially. Thus, according to the aforementioned fabricating process, the organic electroluminescent display panel 200 as shown in FIG. 2 can be produced. Since the detailed fabricating process is similar to the embodiment shown in FIGS. 2A through 2F, detailed description is not repeated.

In summary, the organic electroluminescent display and the method for fabricating the same provided by the present invention have at least the following advantages.
(1) The light-shielding layer is formed to cover the active devices to block the light emitted from the organic functional layer. Therefore the problem of the photo-leakage current can be substantially prevented to provide higher reliability and display quality.
(2) A portion of the transparent electrode may be directly disposed on the light-emitting region of the substrate, therefore the organic functional layer can be formed lower than the active devices to improve the shielding effect.
(3) The light-shielding layer can substantially reduce the light leakage from adjacent pixels to improve the contrast effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic electroluminescent display panel, comprising:
a substrate with a plurality of pixel regions, wherein a device region and a light-emitting region is defined in each pixel region;
an active device array, disposed in the device regions of the substrate;
a transparent electrode layer, disposed over the substrate and coupled to the active device array;
a light-shielding layer, disposed over the substrate, wherein the light-shielding layer at least covers the active device array and exposes the transparent electrode layer in the light-emitting regions;
an organic functional layer, disposed over the transparent electrode layer exposed by the light-shielding layer; and
an upper electrode layer, disposed over the organic functional layer.

2. The organic electroluminescent display panel according to claim 1, further comprising a dielectric layer disposed over the substrate to cover the active device array, wherein the dielectric layer has a plurality of openings to expose a portion of the active device array, and the transparent electrode layer is coupled to the active device array via the openings.

3. The organic electroluminescent display panel according to claim 2, wherein the dielectric layer further exposes the light-emitting regions of the substrate, on which a portion of the transparent electrode layer is disposed.

4. The organic electroluminescent display panel according to claim 1, wherein the active device array comprises a plurality of amorphous silicon thin film transistors (a-Si TFTs) or a plurality of low-temperature poly-silicon thin film transistors (LTPS TFTs).

5. The organic electroluminescent display panel according to claim 1, wherein the material of the transparent electrode layer comprises indium-tin oxide (ITO) or indium-zinc oxide (IZO).

6. The organic electroluminescent display panel according to claim 1, wherein the material of the light-shielding layer is photosensitive resin.

7. The organic electroluminescent display panel according to claim 1, wherein the organic functional layer comprises a hole injection layer, a hole transporting layer, an emitting layer, an electron transporting layer, and an electron injecting layer that are stacked sequentially.

8. A method for fabricating an organic electroluminescent display panel, comprising:
providing an active device array substrate with a plurality of pixel regions, wherein a device region and a light-emitting region is defined in each pixel region, an active device array is formed in the device regions of the substrate, and a transparent electrode layer is formed over the substrate and coupled to the active device array;
forming a light-shielding layer over the substrate, wherein the light-shielding layer at least covers the active device array and exposes the transparent electrode layer in the light-emitting regions;
forming an organic functional layer over the transparent electrode layer exposed by the light-shielding layer; and
forming an upper electrode layer over the organic functional layer.

9. The method according to claim 8, wherein the steps of forming the light-shielding layer comprise:
forming a light-shielding material layer over the substrate; and
patterning the light-shielding material layer to expose the transparent electrode layer in the light-emitting regions.

10. The method according to claim 9, wherein the material of the light-shielding material layer is photosensitive resin, and a photolithography process is performed for patterning the light-shielding material layer.

11. The method according to claim 8, wherein before forming the transparent electrode layer, a dielectric layer with a plurality of openings for exposing a portion of the active device array is formed over the substrate, and the transparent electrode layer is coupled to the active device array via the openings.

12. The method according to claim 11, wherein the dielectric layer further exposes the light-emitting region of the substrate, on which a portion of the transparent electrode layer is disposed.

13. The method according to claim 8, wherein the steps of forming the organic functional layer comprises forming a hole injection layer, a hole transporting layer, an emitting layer, an electron transporting layer, and an electron injection layer sequentially.

14. The method according to claim 8, wherein the active device array comprise amorphous silicon thin film transistors (a-Si TFTs) or low-temperature poly-silicon thin film transistors (LTPS TFTs).
